(19) United States
(12) Patent Application Publication
(10) Pub. No.: US 2026/0348397 A1
(43) Pub. Date: Nov. 5, 2026

(54) TURBINE ENGINE COMPRISING A MOVEABLE UNDUCTED FAN AND A STATIC UNDUCTED FLOW STRAIGHTENER

(71) Applicant: SAFRAN AIRCRAFT ENGINES, Paris (FR)

(72) Inventors: Ludovic BENOIT, Moissy-Cramayel (FR); Bruno Albert BEUTIN, Moissy-Cramayel (FR); Franck Emmanuel BOSCO, Moissy-Cramayel (FR); Charles Gerard Gabriel CAILLIEZ-TOMASI, Moissy-Cramayel (FR)

(21) Appl. No.: 19/473,379

(22) PCT Filed: Apr. 15, 2024
(86) PCT No.: PCT/FR2024/050496

§ 371 Date: Oct. 7, 2025

(30) Foreign Application Priority Data
Apr. 17, 2023 (FR) 2303823

(51) Int. Cl. F04D 29/46; F02K 3/02

(52) U.S. Cl. CPC F04D 29/462; F02K 3/025; F05D 2220/323; F05D 2220/36; F05D 2270/62

(57) ABSTRACT

An aircraft turbine engine including an unducted fan; an unducted flow straightener including at least one guide vane with variable pitch about an axis of rotation; an adjustment system for adjusting the pitch of the guide vane, wherein the adjustment system includes an actuating device intended for actuating the guide vane and including an electric motor; wherein the adjustment system further includes a braking device configured to occupy an active position in which the braking device prevents the guide vane from rotating about the axis of rotation when the actuating device is stationary, and a passive position in which the braking device allows the guide vane to rotate about the axis of rotation when the actuating device is in motion.

### TECHNICAL FIELD OF THE INVENTION

The present invention relates to a turbine engine comprising a moveable unducted fan and a static unducted flow straightener, more specifically to the adjustment of the pitch of the guide vanes of the flow straightener.

### TECHNICAL BACKGROUND

A turbine engine may comprise a moveable unducted fan that is rotated by a turbine associated with a gas generator and a static unducted flow straightener that is configured to straighten at least part of the airflow generated by the fan.

Such a high bypass ratio turbine engine has the advantage of excellent efficiency, with in particular a reduction in fuel consumption and carbon dioxide emissions.

The flow straightener comprises an annular row of variable pitch guide vanes, i.e. guide vanes whose pitch (and more precisely the angle of pitch) can be adjusted as a function of the flight parameters and operating speeds of the turbine engine.

To adjust the pitch of the guide vanes, the turbine engine comprises an adjustment system that may be common to all the guide vanes or specific to each guide vane.

The adjustment system is located in a compartment bounded by an outer fairing that forms the external aerodynamic lines of the turbine engine.

Traditionally, the adjustment system comprises one or more hydraulic actuators and a mechanism specific to each of the guide vanes. Each mechanism comprises several links, for example, and is configured to transform the movement initiated by the hydraulic actuator(s) into a rotational movement of the corresponding guide vane.

One of the disadvantages of such an adjustment system is that it takes up a lot of space.

The engine manufacturers are therefore looking for alternatives to reduce the size of the adjustment system, in particular so that additional equipment can be integrated without having to increase the dimensions of the external aerodynamic lines of the turbine engine.

One solution could be to have an adjustment system comprising an electric motor specific to each of the guide vanes. The rotor of each electric motor would then be linked directly or indirectly to the corresponding guide vane in order to adjust its pitch.

A major disadvantage of this variant is the need to constantly monitor the various electric motors, to the detriment in particular of power consumption and the life of the electric motors.

The aim of the present invention is to improve on the above-mentioned variant, which uses electric motors to overcome the above-mentioned disadvantages.

The prior art also comprises the documents WO2021/165616A1, U.S. Pat. No. 5,242,265A and WO2022/263752A1.

### SUMMARY OF THE INVENTION

The invention thus proposes a turbine engine for an aircraft comprising:
an unducted fan which is movable in rotation about a longitudinal axis X;
an unducted flow straightener that is fixed in rotation about the longitudinal axis X, the flow straightener being configured to straighten at least part of an airflow generated by the unducted fan, the flow straightener comprising at least one guide vane with variable pitch about an axis of rotation Y that is substantially perpendicular to the longitudinal axis X, the guide vane being secured to a shaft that is guided in rotation about the axis of rotation Y in a casing, the casing being fixed to a fixed structure of the turbine engine;
a system for adjusting the pitch of the guide vane, the adjustment system comprising a device for actuating the guide vane about the axis of rotation Y, the actuating device comprising an electric motor;
   characterized in that the adjustment system further comprises a braking device configured to occupy an active position in which the braking device blocks the rotation of the guide vane about the axis of rotation Y when the actuating device is at a standstill, and a passive position in which the braking device allows rotation of the guide vane about the axis of rotation Y when the actuating device is running.

By incorporating a braking device into the adjustment system, the electric motor can be de-energized when the actuating device is at a standstill, thereby optimizing its service life.

The braking device also considerably reduces the electrical requirements of the adjustment system, and therefore of the turbine engine.

The turbine engine according to the invention may comprise one or more of the characteristics, taken in isolation from each other or in combination with each other:
the braking device is mounted in the casing;
the shaft is guided in rotation about the axis of rotation Y in the casing via a first bearing and a second bearing, the braking device being arranged between the first bearing and the second bearing;
the electric motor is mounted on an internal end of the casing with reference to the longitudinal axis X;
the braking device comprises:
   a caliper secured to the casing;
   a disc secured to the shaft and placed in the caliper;
   a piston movable in translation along the axis of rotation Y, the piston being set in motion by an electromagnetic assembly carried by the caliper;
   a compression spring which bears on both the piston and the electromagnetic assembly;
the disc being blocked by the piston under the action of the spring, when the braking device is in the active position, the electromagnetic assembly then not being supplied with electricity;
the disc being released by the piston under the action of the electromagnetic assembly, which is electrically powered, when the braking device is in the passive position, the spring then being compressed by the piston;
the piston comprises a head annular about the axis of rotation Y and several feet projecting from an internal face of the head, each foot comprising a blind orifice in which an electromagnet of the electromagnetic assembly is housed with clearance;
the piston comprises several tabs projecting from a peripheral face of the head, each tab sliding in a groove formed in the caliper, so as to guide the piston in translation relative to the caliper;
the braking device is hydraulic, mechanical or electromagnetic;
the actuating device also comprises an epicyclic train reduction gear which comprises:
   a sun gear movable in rotation about the axis of rotation Y and is secured to a rotor of the electric motor;
   a fixed ring gear that surrounds the sun gear and is secured to the casing;
   at least a planet gear movable in rotation and is in mesh with both the sun gear and the ring gear;
   a planet carrier movable in rotation about the axis of rotation Y and secured to the shaft;
the reduction gear is mounted in the casing;
the planet carrier is made in one piece with the shaft;
the adjustment system comprises a position sensor associated with the shaft or a rotor of the electric motor, so as to measure the pitch of the guide vane;
the adjustment system is controlled by an electronic control card specific to the guide vane;
the turbine engine comprises a ducted fan which is movable in rotation about the longitudinal axis X and which is surrounded by a nacelle, the nacelle internally defining a compartment in which the casing and the adjustment system are located.

### BRIEF DESCRIPTION OF THE FIGURES

The invention will be better understood and other details, characteristics and advantages of the present invention will become clearer from the following description made by way of non-limiting example and with reference to the attached drawings, in which:

FIG. 1 is a schematic longitudinal half-section view of an aircraft turbine engine according to a first embodiment of the invention;

FIG. 2 is a schematic longitudinal half-section view of an aircraft turbine engine according to a second embodiment of the invention;

FIG. 3 is a front view of a system for adjusting the pitch of a guide vane in a flow straightener for the turbine engines illustrated in FIGS. 1 and 2;

FIG. 4 is a longitudinal sectional view of the adjustment system illustrated in FIG. 3;

FIG. 5 is a cross-sectional view of the adjustment system along sectional plane V-V in FIG. 4, with the casing hidden;

FIG. 6 is a perspective view of the adjustment system, with the casing and braking device hidden from view;

FIG. 7 is a detailed view of the braking device of the adjustment system;

FIG. 8 is a detailed view of the disc of the braking device;

FIG. 9 is a detailed view of the braking device, with the electromagnetic assembly of the braking device shown transparently and the caliper of the braking device hidden;

FIG. 10 is a detail view of the braking device, with the electromagnetic assembly and the caliper of the braking device shown transparently;

FIG. 11 is a control diagram for an adjustment system;

FIG. 12 is a control diagram of several adjustment systems.

### DETAILED DESCRIPTION OF THE INVENTION

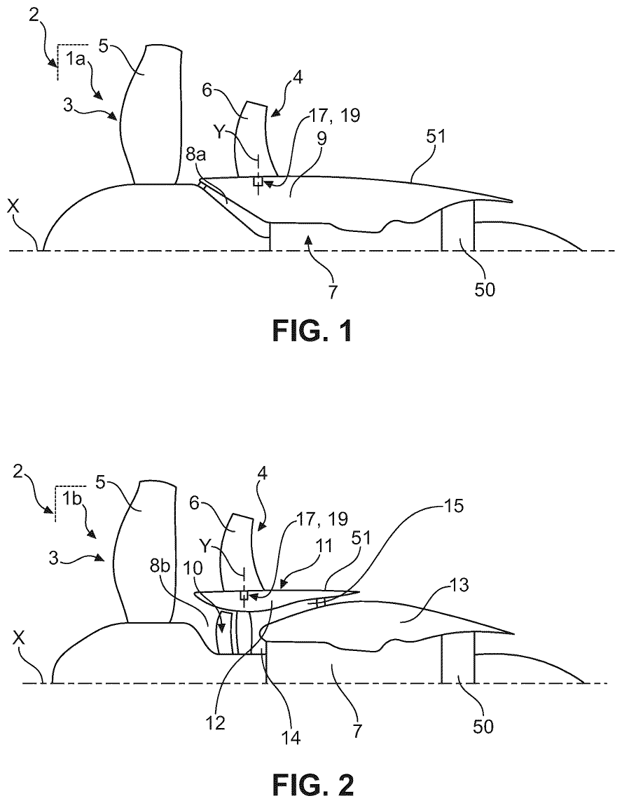

FIGS. 1 and 2 show a turbine engine 1a, 1b with a longitudinal axis X for an aircraft 2, such as an aeroplane. The turbine engine 1a, 1b comprises an unducted fan 3 and an unducted flow straightener 4.

The term “unducted” associated with the fan 3 means that the vanes 5 of the fan 3 are not surrounded at their free end by a fairing. In the same way, the term “unducted” associated with the flow straightener 4 means that the guide vanes 6 of the flow straightener 4 are not surrounded at their free end by a fairing.

As illustrated in FIGS. 1 and 2, the unducted fan 3 can rotate about the axis X and is driven in rotation by a power turbine 50 associated with a gas generator 7 located downstream of the unducted fan 3. The unducted fan 3 comprises an annular row of variable pitch vanes 5.

When the turbine engine 1a, 1b is in “propulsion” mode, the fan 3 generates an airflow which flows from upstream to downstream around the outer fairings 51 of the fused body of the turbine engine 1a, 1b, so as to propel the aircraft 2. The turbine engine 1a, 1b can also operate in “reverser” mode, so as to brake the aircraft 2 when it lands.

By convention in the present application, the terms “upstream” and “downstream” are defined in relation to the direction of flow of the airflow, when the turbine engine 1a, 1b is in “propulsion” mode.

The power turbine 50 (or low-pressure turbine) is designed to rotate the unducted fan 3. The unducted fan 3 can be rotated by the power turbine 50 via a speed reduction gear. The gas generator 7 typically comprises, from upstream to downstream, at least one compressor, a combustion chamber and at least one expansion turbine (or high-pressure turbine). The compressor and expansion turbine are rotationally connected to each other via a drive shaft. The gas generator 7 is supplied with air via an air inlet 8a, 8b which opens out between the unducted fan 3 and the unducted flow straightener 4.

As illustrated in FIGS. 1 and 2, the unducted flow straightener 4 is fixed in rotation about the axis X and is configured to straighten at least part of the airflow generated by the unducted fan 3. The flow straightener 4 is located directly downstream of the unducted fan 3. The flow straightener 4 comprises a row of guide vanes 6 (stator vanes or Outlet guide vanes—OGV) with variable pitch, each guide vane 6 being pitched about an axis of rotation Y which is substantially perpendicular to the axis X.

In the first embodiment shown in FIG. 1, the air inlet 8a feeds directly into the gas generator 7. The air inlet 8a, the gas generator 7 and the power turbine 50 are surrounded by an annular compartment 9 around the axis X, commonly referred to as the “Core compartment”. The guide vanes 6 are arranged around this Core compartment 9.

According to the second embodiment illustrated in FIG. 2, the turbine engine 1b also comprises a ducted fan 10 which is placed in the air inlet 8b, this ducted fan 10 being better known as “Mid-Fan”. The ducted fan 10 is rotatable about the axis X and is driven in rotation by the power turbine 50 (or low-pressure turbine). The ducted fan 10 is surrounded by a nacelle 11 which internally defines an annular compartment 12 around the axis X, commonly referred to as the “Mid-Fan compartment”. The gas generator 7 and the power turbine 50 are surrounded by an annular compartment 13 around the axis X, commonly referred to as the “Core compartment”. The air inlet 8b divides into a primary duct 14 which supplies the gas generator 7 and a secondary duct 15 which is defined between the Core and Mid-Fan compartments 12, 13. The guide vanes 6 are arranged around the Mid-Fan compartment 12, in other words around the nacelle 11.

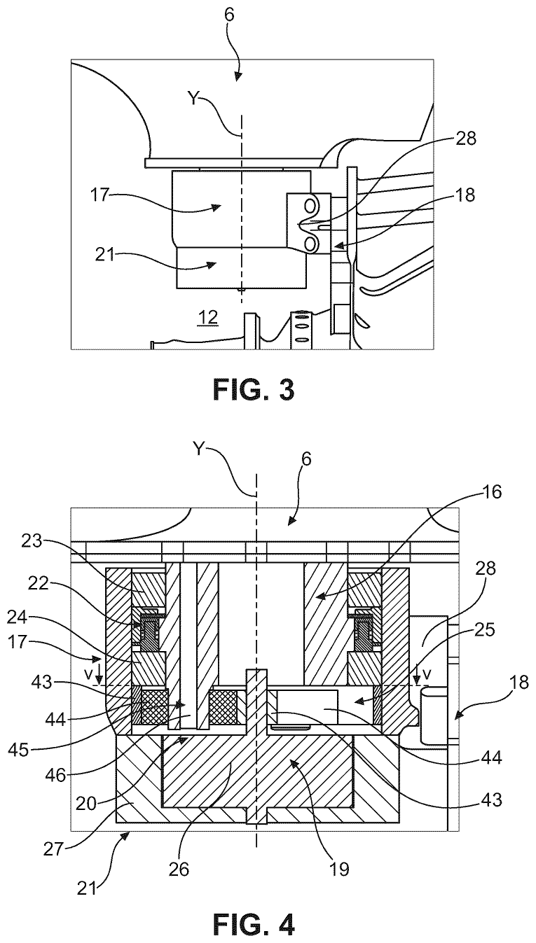

As illustrated in FIGS. 3 and 4, each guide vane 6 is secured to a shaft 16 which is guided in rotation about the axis Y in a casing 17, the casing 17 being fixed to a fixed structure 18 of the turbine engine 1a, 1b. The turbine engine 1a, 1b includes a pitch adjustment system 19 for each guide vane 6. The adjustment system 19 comprises an actuating device 20 for actuating the guide vane 6 about the axis Y, the actuating device 20 comprising an electric motor 21.

According to the invention, the adjustment system 19 further comprises a braking device 22 configured to occupy an active position in which the braking device 22 blocks rotation of the guide vane 6 about the Y axis when the actuating device 20 is at a standstill, and a passive position in which the braking device 22 allows rotation of the guide vane 6 about the axis Y when the actuating device 20 is running.

The term “running” associated with the actuating device 20 means that the actuating device 20 (and in particular the electric motor) generates mechanical power to actuate the guide vane 6 about the axis Y. Conversely, the term “standstill” associated with the actuating device 20 means that the adjustment device 20 (and in particular the electric motor, which is no longer powered) does not generate any mechanical power to actuate the guide vane 6 about the axis Y.

The incorporation of a braking device in the adjustment system means that the electric motor is no longer kept under tension and therefore no longer exerts any torque when the actuating device is at a standstill, thereby optimizing the life of the device and reducing to some extent the electrical power consumed by the system as a whole.

The braking device therefore significantly reduces the electrical requirements of the adjustment system, and consequently of the turbine engine.

The braking device 22 can be mounted inside the casing 17 or outside the casing 17.

The shaft 16 can be guided in rotation about the axis Y in the casing 17 via a first bearing 23 and a second bearing 24. In this case, the braking device 22 is advantageously located between the first bearing 23 and the second bearing 24. This arrangement of the braking device 22 ensures optimum alignment between the movable and fixed parts of the braking device 22.

The electric motor 21 can be a DC motor, a stepper motor, an AC motor, etc.

The electric motor 21 can be single-coil or double-coil, if redundancy is required.

The electric motor 21 can be mounted inside the casing 17 or outside the casing 17.

The braking device 22 can be electromagnetic, hydraulic, mechanical, etc.

The actuating device 20 may also comprise a gear train reduction gear, preferably an epicyclic train reduction gear 25.

A gear train reduction gear allows the output speed to be reduced while increasing the output torque.

An epicyclic train reduction gear 25 has the advantage of having a high reduction ratio while being compact.

The gear train reduction gear may comprise one or more reduction stages, depending on the desired reduction ratio.

The adjustment system 19 may comprise a position sensor associated with the shaft 16 or a rotor 26 of the electric motor 21, so as to measure the pitch of the guide vane 6, and thus precisely control the guide vane 6.

The position sensor can be an RVDT (Rotary Variable Differential Transformer) angular sensor or an LVDT (Linear Variable Differential Transformer) linear sensor.

The various adjustment systems 19 can be controlled independently, together or in groups (two or three, for example).

In the embodiment illustrated in FIGS. 3 to 10, the adjustment system 19 comprises an actuating device 20, in this case a gear motor, and an electromagnetic braking device 22.

The gear motor 20 comprises the electric motor 21 and an epicyclic train reduction gear 25.

The guide vane 6 is attached to the shaft 16 by fastening means, which may be screws.

As shown in FIG. 4, the casing 17 internally defines a housing in which two roller bearings 23, 24 are mounted to guide the shaft 16, the electromagnetic braking device 22 arranged between the two roller bearings 23, 24 and the epicyclic train reduction gear 25.

The electric motor 21 is mounted on an internal end of the casing 17 with reference to the axis X. More specifically, the motor 21 comprises a stator 27 fixed to the inner end of the casing 17 via, for example, an annular row of screws around the axis Y, and a rotor 26 which is movable in rotation around the axis Y.

As shown in FIG. 3, the casing 17 externally comprises a bracket 28 which is fixed to the fixed structure 18 of the turbine engine 1a, 1b via two bolts, for example.

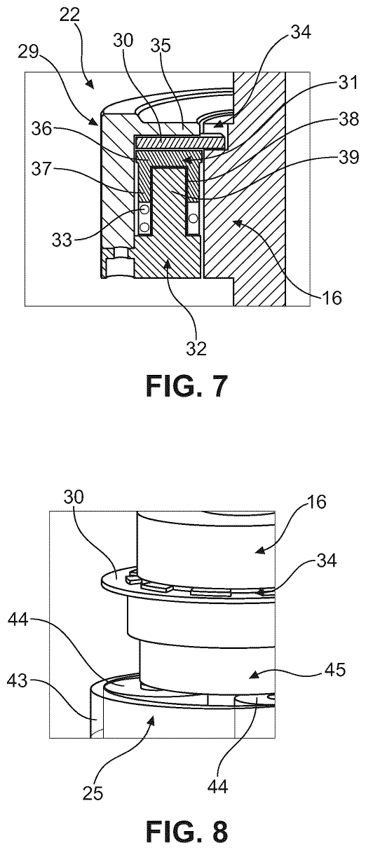

As illustrated in particular in FIGS. 4 and 7, the electromagnetic braking device 22 comprises:
a caliper 29 secured to the casing 17;
a disc 30 secured to the shaft 16 and placed in the caliper 29;
a piston 31 movable in translation along the axis Y, the piston 31 being set in motion by an electromagnetic assembly 32 which is carried by the caliper 29;
a compression spring 33 which bears on both the piston 31 and the electromagnetic assembly 32.

The disc 30 is blocked by the piston 31 under the action of the spring 33, when the braking device 22 is in the active position. The electromagnetic assembly 32 is then not supplied with electricity. The braking device 22 is therefore normally in the active position.

The disc 30 is released by the piston 31 under the action of the electromagnetic assembly 32, which is electrically powered, when the braking device 22 is in the passive position. The spring 33 is then compressed by the piston 31.

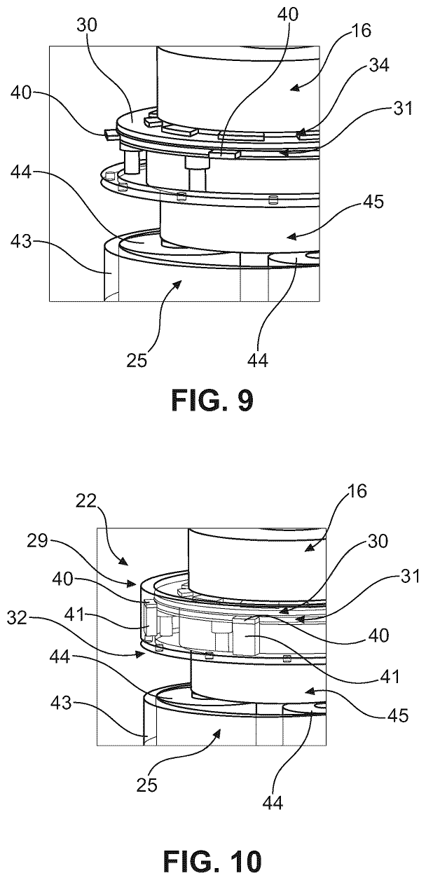

As illustrated in particular in FIGS. 8 and 9, the disc 30 is secured to the shaft 16 via grooves 34 of complementary shape. The disc 30 is located directly between a wing 35 of the caliper 29 and the piston 31.

As illustrated in FIGS. 4, 7 and 9, the piston 31 comprises a head 36 annular about the axis Y and several feet 37 projecting from an internal face of the head 36. The feet 37 are evenly distributed around the axis Y. Each foot 37 comprises a blind orifice 38 in which an electromagnet 39 of the electromagnetic assembly 32 is housed with clearance.

Each electromagnet 39 comprises an iron core surrounded by a coil which may or may not be electrically powered, depending on the active or passive position of the braking device 22.

As illustrated in FIGS. 9 and 10, the piston 31 also comprises a number of tabs 40 projecting from a peripheral face of the head 36. The tabs 40 are evenly spaced around the axis Y. Each tab 40 slides in a groove 41 formed in the caliper 29, so as to guide the piston 31 in translation with respect to the caliper 29.

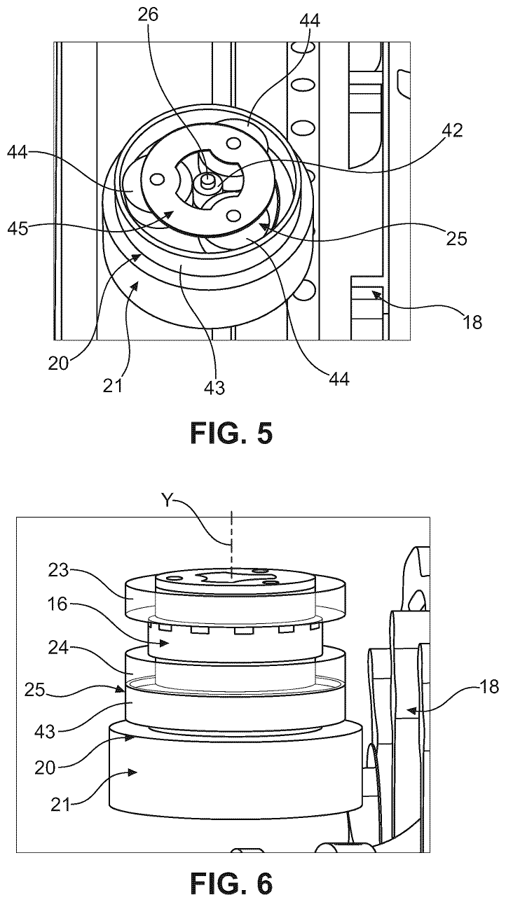

As illustrated in FIGS. 4 and 5, the epicyclic train reduction gear 25 comprises:
a sun gear 42 (or planetary gear) movable in rotation about the axis Y and is secured to the rotor 26 of the electric motor 21;
a fixed ring gear 43 which surrounds the sun gear 42 and is secured to the casing 17;
three planet gears 44 mobile in rotation, each planet gear 44 being in mesh with both the sun gear 42 and the ring gear 43;
a planet carrier 45 movable in rotation about the axis Y and is secured to the shaft 16.

More specifically, as shown in FIG. 5, the three planet gear 44 are evenly distributed around the axis Y. Each planet gear 44 is guided in rotation on a finger 46 of the planet carrier 45 via one or more bearings.

The rotor 26 of the electric motor 21 is connected in rotation with the sun gear 42 by connecting means (e.g. splines) or by shrink fitting.

As shown in FIG. 4, the planet carrier 45 is made in one piece (or integrally formed) with the shaft 16, so that the planet carrier 45 and the shaft 16 are in one piece. Alternatively, the planet carrier 45 could be attached and fixed to the shaft 16, for example using screws or bolts.

The adjustment system 19 is supplied electrically via a power management unit (PMU) which may already be installed in the turbine engine 1a, 1b to supply other equipment, namely one or more de-icing devices and/or one or more electrical machines configured to operate in “motor” and “generator” mode, or which may be installed in the turbine engine 1a, 1b specifically for the adjustment system 19. The electrical machines are designed to participate in the electrical hybridisation of turbine engine 1a, 1b.

The gear motor 20 and the electromagnetic braking device 22 are thus connected to the power management unit via one or more electrical harnesses. It is possible to use a single electrical harness for different power supplies, for example an electric motor and a defrosting device, to minimise space requirements.

According to the embodiment illustrated in FIG. 1, the casing 17 and the adjustment system 19 associated with each of the guide vanes 6 are located in the Core compartment 9.

According to the embodiment illustrated in FIG. 2, the casing 17 and the adjustment system 19 associated with each of the guide vanes 6 are located in the Mid-Fan compartment 12.

As far as assembly is concerned, the complete casings 17 are assembled before the turbine engine 1a, 1b is sent to the aircraft manufacturer. So, when the turbine engine 1a, 1b arrives at the aircraft manufacturer, all that remains to be done is to secure each guide vane 6 to the corresponding shaft 16.

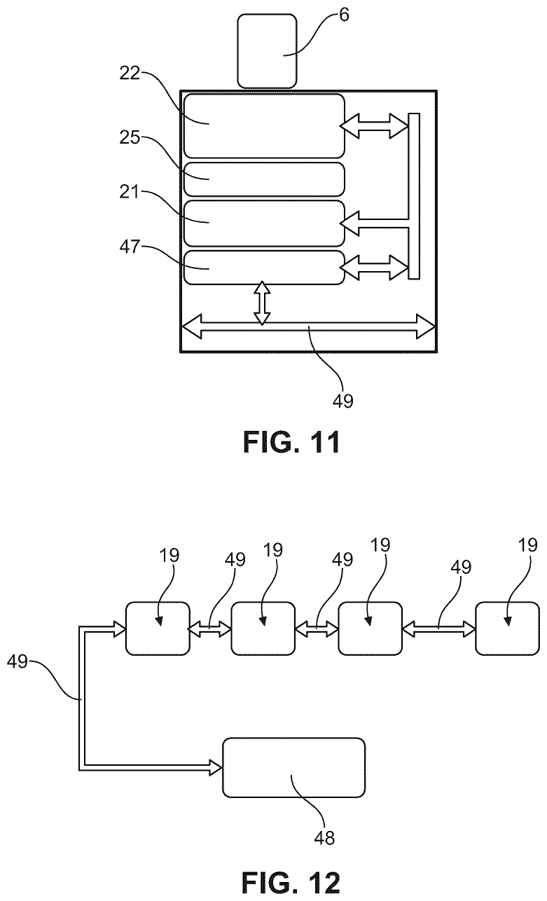

As shown in FIG. 11, each adjustment system 19 is controlled by an electronic control card 47 specific to the guide vane 6. Each electrical control board 47 is associated with a unique identifier so that the mounting position of each adjustment system 19 on the turbine engine can be known.

As shown in FIG. 12, the various electronic control cards are connected to a control box 48, which is common to all the guide vanes 6, via a communication network 49. The control box 48 is connected to one or more electrical engine control units (EEC)

When the electronic control card 47 receives a pitch setpoint, the braking device 22 moves to the passive position and the actuating device 20 starts running to obtain the desired pitch. Once the adjustment has been made, the braking device 22 returns to its active position and the control box 48 is informed of this new angular position via the communications network 49.

The control box 48 can send either a common setpoint to all the electronic control boards (in absolute or relative mode) or a specific setpoint to one or more electronic control boards using their identifier. The control box 48 confirms the new angular positions to the electronic control unit(s), generally on the two channels of each of the electronic control units.

As an alternative to the method illustrated in FIGS. 11 and 12, the adjustment systems 19 can be controlled directly by one or more electronic engine control units (EEC). The adjustment systems 19 can then be supplied with all or part of their electrical power by the electronic engine control unit(s). This variant allows the guide vanes 6 to be controlled together. To increase the safety of the turbine engine, the rotors 26 of the electric motors 21 can be connected together by flexshafts, so that all the guide vanes 6 are synchronised even if one of the electric motors 21 fails.

The embodiments illustrated in FIGS. 1 and 2 are by no means limitative. For example, with reference to FIG. 1, the unducted fan 3 could be arranged downstream of the gas generator 7 and the power turbine 50, with the unducted flow straightener 4 upstream of the unducted fan 3.

1. A turbine engine for an aircraft comprising:
an unducted fan which is movable in rotation about a longitudinal axis;
an unducted flow straightener which is fixed in rotation about the longitudinal axis, the flow straightener being configured to straighten at least part of an airflow generated by the unducted fan, the flow straightener comprising at least one guide vane with variable pitch about an axis of rotation that is substantially perpendicular to the longitudinal axis, the guide vane being secured to a shaft that is guided in rotation about the axis of rotation in a casing, the casing being fixed to a fixed structure of the turbine engine;
a system for adjusting the pitch of the guide vane, the adjustment system comprising a device for actuating the guide vane about the axis of rotation, the actuating device comprising an electric motor;
wherein the adjustment system further comprises a braking device configured to occupy an active position in which the braking device blocks the rotation of the guide vane about the axis of rotation when the actuating device is at a standstill, and a passive position in which the braking device allows rotation of the guide vane about the axis of rotation when the actuating device is running.

2. The turbine engine according to claim 1, wherein the braking device is mounted in the casing.

3. The turbine engine according to claim 2, wherein the shaft is guided in rotation about the axis of rotation in the casing via a first bearing and a second bearing, the braking device being arranged between the first bearing and the second bearing.

4. The turbine engine according to claim 1, wherein the electric motor is mounted on an internal end of the casing with reference to the longitudinal axis.

5. The turbine engine according to claim 1, wherein the braking device comprises:
a caliper secured to the casing;
a disc secured to the shaft and placed in the caliper;
a piston movable in translation along the axis of rotation, the piston being set in motion by an electromagnetic assembly carried by the caliper;
a compression spring which bears on both the piston and the electromagnetic assembly;
the disc being blocked by the piston under the action of the spring, when the braking device is in the active position, the electromagnetic assembly then not being supplied with electricity;
the disc being released by the piston under the action of the electromagnetic assembly, which is electrically powered, when the braking device is in the passive position, the spring then being compressed by the piston.

6. The turbine engine according to claim 5, wherein the piston comprises a head annular about the axis of rotation and several feet projecting from an internal face of the head, each foot comprising a blind orifice in which an electromagnet of the electromagnetic assembly is housed with clearance.

7. The turbine engine according to claim 6, wherein the piston comprises several tabs projecting from a peripheral face of the head, each tab sliding in a groove formed in the caliper so as to guide the piston in translation relative to the caliper.

8. The turbine engine according to claim 1, wherein the braking device is hydraulic or mechanical or electromagnetic.

9. The turbine engine according to claim 1, wherein the actuating device further comprises an epicyclic train reduction gear which comprises:
a sun gear movable in rotation about the axis of rotation and secured to a rotor of the electric motor;
a fixed ring gear which surrounds the sun gear and is secured to the casing;
at least one planet gear movable in rotation and meshed with both the sun gear and to the ring gear;
a planet carrier movable in rotation about the axis of rotation and is secured to the shaft.

10. The turbine engine as claimed in claim 9, wherein the reduction gear is mounted in the casing.

11. The turbine engine according to claim 9, wherein the planet carrier is made in one piece with the shaft.

12. The turbine engine according to claim 1, wherein the adjustment system comprises a position sensor associated with the shaft or with a rotor of the electric motor, so as to measure the pitch of the guide vane.

13. The turbine engine according to claim 1, wherein the adjustment system is controlled by an electronic control card which is specific to the guide vane.

14. The turbine engine according to any claim 1, wherein the turbine engine comprises a ducted fan which is movable in rotation about the longitudinal axis and which is surrounded by a nacelle, the nacelle internally defining a compartment in which the casing and the adjustment system are located.
